(19) United States
(12) Patent Application Publication
(10) Pub. No.: US 2024/0278205 A1
(43) Pub. Date: Aug. 22, 2024

(54) LARGE-VOLUME ULTRASONIC TUBULAR REACTOR

(71) Applicant: MOGE UM-FLOW TECHNOLOGY (SHANTOU) CO., LTD., Shantou, Guangdong (CN)

(72) Inventor: Zhengya Dong, Shantou, Guangdong (CN)

(21) Appl. No.: 18/294,179

(22) PCT Filed: Jul. 19, 2022
(86) PCT No.: PCT/CN2022/106576

§ 371 Date: Feb. 1, 2024

(30) Foreign Application Priority Data
Aug. 19, 2021 (CN) 202110953049.9

(51) Int. Cl. B01J 19/10; B01J 19/18

(52) U.S. Cl. CPC B01J 19/10; B01J 19/1812; B01J 2219/0869

(57) ABSTRACT

The present invention discloses a large-volume ultrasonic tubular reactor including, in order from top to bottom: an ultrasonic transducer for generating ultrasound waves; an amplitude transformer, a tool head and a fluid tube. the fluid tube is provided inside the tool head away from the side of the tool head connected to the amplitude transformer, or is connected to the outer side surface of the side of the tool head away from the amplitude transformer. The amplitude transformer is used for transferring the ultrasonic waves generated by the ultrasonic transducer to the tool head. The present invention enables a low processing cost of the fluid tube, easier connection of the fluid tube to the tool head, and ensures the convergence of dispersed ultrasonic energy into the fluid tube while the length and volume of the fluid tube is large.

### FIELD OF THE INVENTION

The present invention relates to the technical field of ultrasonic equipment, and specifically relates to a large-volume ultrasonic tubular reactor.

### BACKGROUND OF THE INVENTION

Tube-based continuous reactors are being widely used in the synthesis of fine chemicals and pharmaceutical materials due to the advantages of fast heat and mass transfer, controllable multiphase flow, safe process, low equipment cost, simple operation and rapid scale-up. However, these tubular reactors also suffer from weak convective mixing, and easy clogging by solids. Combining ultrasonic waves with tubular reactors and utilizing the mechanical mixing and cleaning effects of the ultrasonic cavitation effect is a good solution to this problem. However, designing a stable and efficient ultrasonic tubular reactor that can be scaled up is complex and requires consideration of how the dispersed ultrasonic energy can converge into the fluid tube.

The Chinese invention patent No. CN104923468B discloses a high-power ultrasonic microreactor (microchannel reactor). The microchannel reactor is directly and rigidly connected to the ultrasonic transducer through the front radiation surface of the ultrasonic transducer, so that the microreactor and the ultrasonic transducer are vibrated as a whole. The wavelength of the ultrasonic wave generated by the vibration in the direction perpendicular to the front radiation surface is twice the distance from the upper surface of the microreactor to the rear face of the rear cover plate. The upper surface of the microreactor refers to its side surface opposite the ultrasonic transducer, the rear face of the rear cover plate refers to its side surface away from the piezoelectric ceramic stack. The distance from the upper surface of the microreactor to the rear face of the rear cover plate represents the length of the ultrasonic microreactor in the direction perpendicular to the front radiation surface. The fluid tube of this reactor is located in a reactor plate which is combined with the front radiation surface of a sandwich transducer, and the whole device forms a half-wave oscillator in the longitudinal direction to achieve resonance, thereby converging ultrasound energy into the tube within the reactor plate. The ultrasonic energy efficiency of the reactor is high and the structure is simple, but the ultrasonic amplification is difficult, the radiation area of the ultrasonic transducer is limited and the length of the tube that can be contacted is limited, which is not conducive to a large-volume ultrasonic tubular reactor.

The Chinese invention patent with the application number of 202011513520.4 discloses an ultrasonic tubular reactor, including an ultrasonic transducer, an amplitude transformer, a cylindrical tool head and a fluid tube. One end of the amplitude transformer is connected to the ultrasonic transducer, and the other end is connected to the tool head, and the fluid tube is arranged in a twisted form on a vibration wall of the tool head. Ultrasonic waves are reflected at the vibration wall, generating a radial resonance standing wave, and the vibrating wall of the tool head is located at the antinode of the resonance standing wave. The energy of the ultrasonic waves is radiated from the vibrating wall and conducted into the fluid tube. The large surface area of the vibration wall allows for contact with a greater number of fluid tubes, enabling the production of larger volume ultrasonic reactors. However, the tool head of the reactor is cylindrical, and the spiral-shaped fluid tube is arranged in a twisted arrangement on the vibration wall of the tool head, so the spiral-shaped fluid tube is costly to process, and it is more difficult to firmly connect the tube to the vibration wall.

### SUMMARY OF THE INVENTION

In order to solve the above technical problems, an object of the present invention is to provide a large-volume ultrasonic tubular reactor. This objective is achieved by using a column-shaped tool head structure where the fluid tube is located inside the tool head, away from the side connected to the amplitude transformer, or connected to the outer side surface of the tool head opposite the amplitude transformer. This arrangement ensures a low processing cost of the fluid tube, easier connection of the fluid tube to the tool head, and ensure that dispersed ultrasonic energy is converged into the fluid tube while the length and volume of the fluid tube is large.

The technical solutions adopted in the present invention to realize the above-mentioned object of the present invention are as follows:

A large-volume ultrasonic tubular reactor, including:
an ultrasonic transducer for generating ultrasound waves;
an amplitude transformer, one end of which being connected to the ultrasonic transducer;
a tool head, one end of which being connected to the other end of the amplitude transformer;
a fluid tube, the fluid tube being provided inside the tool head away from the side of the tool head connected to the amplitude transformer, or the fluid tube being connected to the outer side surface of the side of the tool head away from the amplitude transformer which is used for transferring the ultrasonic waves generated by the ultrasonic transducer to the tool head, which is used to converge the ultrasonic energy inside the tool head into the fluid tube. This arrangement enhances the mixing of the fluid within the tube.

More preferably, when the fluid tube is connected to the outer wall of the lower side of the tool head, the fluid tube is a hollow tube, which can be made of a plastic polymer (e.g., polytetrafluoroethylene PFA), or a material such as glass, metal, alloy, composite material, etc. The fluid tube and the lower side of the tool head can be glued with rigid epoxy resin.

Preferably, the tool head has a columnar structure along its length direction, the height direction of the tool head is the same as the length direction of the amplitude transformer, and the width of the tool head extending along the width direction of the tool head is smaller than the length of the tool head extending along the length direction of the tool head.

Preferably, the tool head has a flat columnar structure along its length direction.

Preferably, the tool head has a height of half the wavelength of the ultrasonic waves, and the ultrasonic waves vibrate longitudinally along the height direction within the tool head. This is arranged so that the tool head resonates along the height direction, and the vibration amplitude of the tool head is greatest on a side (that is, the lower side of the tool head) further away from another side of the tool head at which the tool head is connected to the amplitude transformer. The fluid tube is located just inside the tool head near the lower side or the fluid tube is connected to the outer side surface of the lower side. In this way, the ultrasonic energy is maximized into the fluid tube, intensifying the mixing of the fluid.

Preferably, the tool head has a length of 20-1000 mm and has a width of 10-1000 mm.

Preferably, the tool head has a length of 50-500 mm and has a width of 15-60 mm. Generally, a longer tool head is more favorable for increasing the length and volume of the fluid tube. However, the longer the tool head is, the more difficult it is to keep a uniform distribution of the ultrasonic amplitude along the length direction. If the width of the tool head is too wide, the vibration amplitude of the ultrasonic waves along the width direction will be uneven. Therefore, the tool head of the embodiment is provided with such length and width dimensions to ensure that the ultrasonic amplitude distribution along both the length direction and the width direction remains uniform under the premise that the fluid tube has sufficient length and volume.

Preferably, the width of the tool head on the side of the tool head connected to the amplitude transformer is greater than or equal to the width of the tool head away from the side of the tool head connected to the amplitude transformer.

More preferably, the width of the tool head on the side of the tool head connected to the amplitude transformer is greater than the width of the tool head away from the side of the tool head connected to the amplitude transformer, i.e., the width of the upper side of the tool head is greater than the width of the lower side along the height direction from top to bottom of the tool head. This arrangement enables the cross section of the tool head in the height direction to have a rectangular deformation structure, so that the tool head has an upper wide and lower narrow structure in the height direction. The tool head is arranged in a multi-section flat columnar structure. The tool head includes a first head portion, a second head portion and a third head portion, wherein the first head portion is connected to the lower end of the amplitude transformer, the second head portion is located between the first head portion and the third head portion, and the tool head is integrally formed. The lower end surface of the third head portion is the lower side of the tool head, the fluid tube is located in the third head portion, and the first head portion and the third head portion are both preferably rectangular parallelepiped. The width of the first head portion is greater than the width of the third head portion, the second head portion is a transition section between the first head portion and the third head portion, and the side walls on two sides in the width direction of the second head portion are straight inclined side walls or arc-shaped walls. The upper side of the second head portion possesses a greater width than the lower side. This arrangement is such that the second head portion presents a straight inclined transition or a circular arc transition, so that more ultrasonic waves converge into the fluid tube in the third head portion.

More preferably, the width of the lower side of the tool head is preferably 0.25-0.75 times the width of the upper side. The width of the lower side is smaller than the width of the upper side in order to allow for a greater ultrasonic amplitude near the lower side within the tool head, allowing more energy to converge into the fluid tube.

Preferably, the tool head is provided with at least one hollow groove along the length direction of the tool head, the hollow groove is provided extending along the height direction of the tool head and penetrating from one side wall in the width direction of the tool head to the other side wall.

More preferably, the amplitude transformer is connected to the center point of the tool head along the length direction, and such an arrangement will inevitably lead to a larger ultrasonic amplitude in the center of the tool head along the length direction and smaller on both sides. This problem can be solved by the hollow groove, which scatters the ultrasonic waves and redistributes the sound field so that it is more evenly distributed along the length direction of the tool head.

More preferably, the hollow groove is provided near the side of the tool head that is connected to the amplitude transformer. The hollow groove may be defined in the first head portion and extend to the second head portion.

Preferably, the amplitude transformer is a stepped cylinder or a stepped round platform, the ultrasonic waves vibrate along the length direction of the amplitude transformer, and the total length of the amplitude transformer is an integer multiple of half the wavelength of the ultrasonic waves. The ultrasonic waves generated by the ultrasonic transducer usually vibrate in the longitudinal direction, i.e., the ultrasonic waves vibrate along the length direction of the ultrasonic transducer and the amplitude transformer. This arrangement enables the amplitude transformer to reach resonance along the length direction when the ultrasonic waves vibrate along the longitudinal direction, and the vibration amplitude of the amplitude transformer is maximized at the end connected to the tool head, so as to maximize the excitation of the vibration of the tool head.

Preferably, one or more fluid tubes are provided, and the fluid tubes are arranged along the length direction of the tool head.

Preferably, when the fluid tube is provided inside the tool head away from the side of the tool head connected to the amplitude transformer, the fluid tube is directly formed on the tool head, and the fluid tube is a straight tube. When there are a plurality of tubes, the fluid tubes are provided in a way of being arranged in series or in parallel with each other, i.e., in a way of being arranged in series in which one end of one fluid tube is connected to one end of the other fluid tube through a connecting tube, so as to make the plurality of fluid tubes are connected to each other; Alternatively, a plurality of groups of fluid tubes are provided along the height direction of the tool head, each group of fluid tubes is provided at the same height, and each group of fluid tubes is connected by the connecting tube, so that the plurality of groups of interconnected fluid tubes are provided in parallel with each other along the height direction of the tool head, thereby forming a manner in which the fluid tubes are provided in parallel.

Preferably, the fluid tube has a circular cross-section, in other embodiments, the fluid tube has a rectangular or polygonal cross-section with an equivalent diameter of 0.1-20 mm, preferably 1-5 mm.

The present invention achieves the following advantageous technical effects with respect to the prior art:

The large-volume ultrasonic tubular reactor of the present invention is provided with a tool head structure in the shape of a column. The fluid tube is provided inside the tool head away from the side of the tool head connected to the amplitude transformer or the fluid tube connected to the outer side surface of the side of the tool head away from the amplitude transformer, so as to enable a low processing cost of the fluid tube, easier connection to the tool head, and ensure that dispersed ultrasonic energy is converged into the fluid tube while the length and volume of the fluid tube is large, so as to intensify the mixing of the fluid in the fluid tube. The width of the lower side of the tool head is preferably 0.25-0.75 times the width of the upper side, and the width of the lower side is smaller than the width of the upper side, which allows for a greater amplitude of ultrasonic waves near the lower side within the tool head, and allows for more energy to converge into the fluid tube. At the same time, the hollow groove provided on the tool head can scatter the ultrasonic waves, redistribute the acoustic field, make the ultrasonic waves more evenly distributed along the length direction of the tool head, and avoid the problem of larger ultrasonic amplitude in the center of the tool head along the length direction and smaller ones on both sides caused by the amplitude transformer being connected to the center point of the tool head along the length direction.

### BRIEF DESCRIPTION OF THE DRAWINGS

FIG. 1 is a front view of a large-volume ultrasonic tubular reactor according to embodiment 1 of the present invention;

FIG. 2 is a side view of a tool head in the large-volume ultrasonic tubular reactor according to embodiment 1 of the present invention;

FIG. 3 is a side view of a tool head in a large-volume ultrasonic tubular reactor according to embodiment 2 of the present invention;

FIG. 4 is a side view of a tool head in a large-volume ultrasonic tubular reactor according to embodiment 3 of the present invention;

FIG. 5 is a front view of a large-volume ultrasonic tubular reactor according to embodiment 5 of the present invention;

FIG. 6 is a side view of a tool head in a large-volume ultrasonic tubular reactor according to embodiment 6 of the present invention.

Here, the technical features referred to by each of the reference symbols are as follows:
1. ultrasonic transducer; 2. amplitude transformer; 3. tool head; 31. length direction of tool head; 32. height direction of tool head; 33. width direction of tool head; 34. first head portion; 35. second head portion; 36. third head portion; 4. fluid tube; 5. hollow groove; 6. connecting tube.

### DETAILED DESCRIPTION OF THE INVENTION

In order to make the objects, technical solutions and advantages of the present invention clearer and more understandable, the present invention is described in further detail in the following in connection with the embodiments, but the scope of the claimed protection of the present invention is not limited to the following specific embodiments.

### Embodiment 1

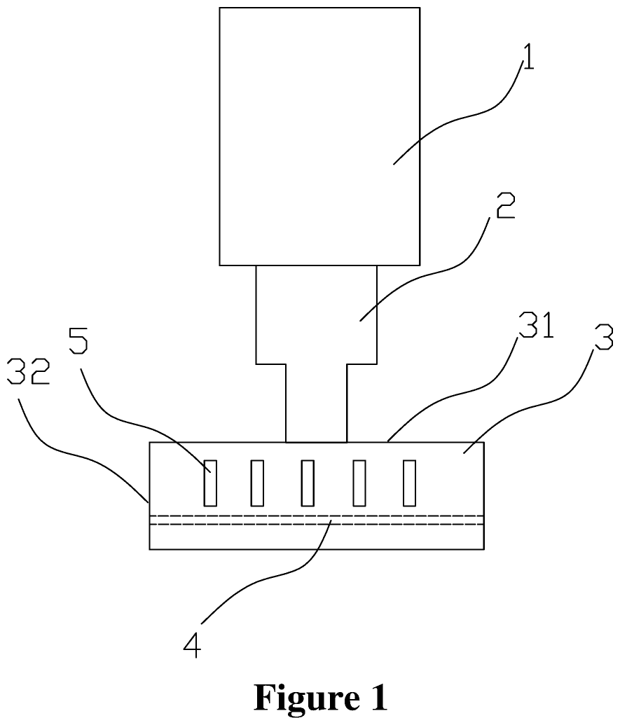

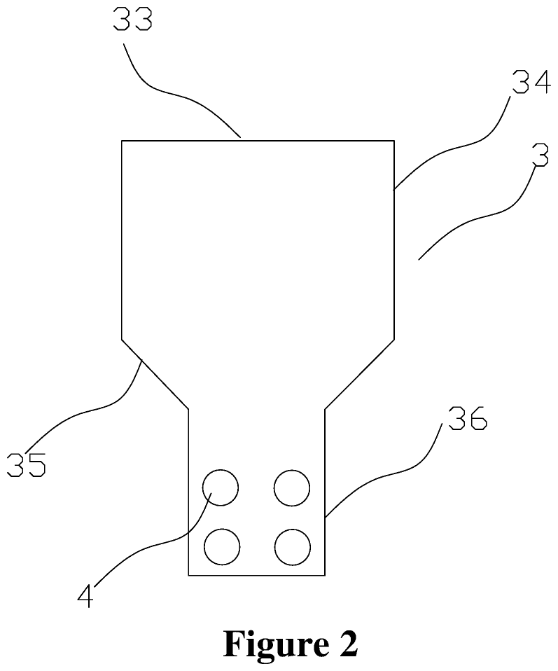

Referring to FIG. 1 and FIG. 2, this embodiment discloses a large-volume ultrasonic tubular reactor including, in order from top to bottom: an ultrasonic transducer 1, an amplitude transformer 2, a tool head 3, and a fluid tube 4. Wherein the ultrasonic transducer 1 is used for generating ultrasonic waves. One end of the amplitude transformer 2 is connected to the ultrasonic transducer 1, and one end of the tool head 3 is connected to the other end of the amplitude transformer 2.

The fluid tube 4 is provided inside the tool head 3 away from the side of the tool head 3 connected to the amplitude transformer 2. The amplitude transformer 2 is used to transmit ultrasonic waves generated by the ultrasonic transducer 1 to the tool head 3, and the tool head 3 is used to converge the ultrasonic energy inside the tool head 3 into the fluid tube 4. This arrangement can intensify the mixing of the fluid in the fluid tube 4. The fluid tube 4 has a circular cross-section, in other embodiments, the fluid tube 4 has a rectangular or polygonal cross-section with an equivalent diameter of 0.1-20 mm, preferably 1-5 mm. One fluid tube 4 is provided, and the fluid tube 4 is arranged along the length direction of the tool head 3.

The tool head 3 has a columnar structure along the length direction, and the tool head 3 has three directions, namely, a length direction of tool head 31, a height direction of tool head 32, and a width direction of tool head 33. The height direction of the tool head 3 is the same as the length direction of the amplitude transformer 2. The length direction of the tool head 3 is perpendicular to the width direction of the tool head 3 in the front direction, and the width of the tool head 3 extending along the width direction is less than the length of the tool head 3 extending along the length direction.

The amplitude transformer 2 is a stepped cylinder or a stepped round platform, the ultrasonic waves vibrate along the length direction of the amplitude transformer 2, and the total length of the amplitude transformer 2 is an integer multiple of half the wavelength of the ultrasonic waves. The up and down directions of the ultrasonic transducer 1 and the amplitude transformer 2 in FIG. 1 are the length directions of the ultrasonic transducer 1 and the amplitude transformer 2. The ultrasonic waves generated by the ultrasonic transducer 1 usually vibrate in the longitudinal direction, i.e., the ultrasonic waves vibrate along the length direction of the ultrasonic transducer 1 and the amplitude transformer 2. This arrangement allows the amplitude transformer 2 to reach resonance along the length direction when the ultrasonic waves vibrate along the longitudinal direction, and the vibration amplitude of the amplitude transformer 2 is maximized at the end connected to the tool head 3, so as to maximize the excitation of the vibration of the tool head 3.

The tool head 3 has a height of half the wavelength of the ultrasonic waves, and the ultrasonic waves vibrate longitudinally along the height direction within the tool head 3. This is arranged so that the tool head 3 resonates along the height direction and the vibration amplitude of the tool head 3 is greatest on a side away from the side of the tool head 3 connected to the amplitude transformer 2, which is the lower side of the tool head 3. The fluid tube 4 is located just inside the tool head 3 near the lower side or the fluid tube 4 is connected to the outer side surface of the lower side. In this way, the ultrasonic energy is maximized into the fluid tube 4, intensifying the mixing of the fluid.

The tool head 3 has a length of 20-1000 mm and a width of 10-1000 mm. It is further preferred in this embodiment that the tool head 3 has a length of 50-500 mm and a width of 15-60 mm. In general, the greater the length of the tool head 3 is, the more favorable it is to increase the length and volume of the fluid tube 4. However, the longer the tool head 3 is, the more difficult it is to keep a uniform distribution of the ultrasonic amplitude along the length direction. If the width of the tool head 3 is too wide, the vibration amplitude of the ultrasonic waves along the width direction will be uneven. Therefore, the tool head 3 of the embodiment is provided with such length and width dimensions to ensure that the ultrasonic amplitude distribution along both the length direction and the width direction remains uniform under the premise that the fluid tube 4 has sufficient length and volume.

It is further preferred in this embodiment that the tool head 3 has a flat columnar structure along the length direction. The width of the tool head 3 on the side of the tool head 3 connected to the amplitude transformer 2 is greater than or equal to the width of the tool head 3 away from the side of the tool head 3 connected to the amplitude transformer 2. Preferably in this embodiment, the width of the tool head 3 on the side of the tool head 3 connected to the amplitude transformer 2 is greater than the width of the tool head 3 away from the side of the tool head 3 connected to the amplitude transformer 2, i.e., the width of the upper side of the tool head 3 is greater than the width of the lower side along the height direction from top to bottom of the tool head 3. This arrangement enables the cross section of the tool head 3 in the height direction to have a rectangular deformation structure, so that the tool head 3 has an upper wide and lower narrow structure in the height direction. The tool head 3 is arranged in a multi-section flat columnar structure. The tool head 3 includes a first head portion 34, a second head portion 35 and a third head portion 36. Wherein the first head portion 34 is connected to the lower end of the amplitude transformer 2, the second head portion 35 is located between the first head portion 34 and the third head portion 36, and the tool head 3 is integrally formed. The lower end surface of the third head portion 36 is the lower side of the tool head 3, the fluid tube 4 is located in the third head portion 36, and the first head portion 34 and the third head portion 36 are both preferably rectangular parallelepiped. The width of the first head portion 34 is greater than the width of the third head portion 36, the second head portion 35 is a transition section between the first head portion 34 and the third head portion 36, and the side walls on two sides in the width direction of the second head portion 35 are straight inclined side walls or arc-shaped walls. The upper side of the second head portion 35 has a greater width than the lower side. This arrangement is such that the second head portion 35 presents a straight inclined transition or a circular arc transition, so that more ultrasonic waves converge into the fluid tube 4 in the third head portion 36.

The width of the lower side of the tool head 3 is preferably 0.25-0.75 times the width of the upper side. The width of the lower side is smaller than the width of the upper side in order to allow for a greater ultrasonic amplitude near the lower side within the tool head 3, allowing more energy to converge into the fluid tube 4.

The tool head 3 is provided with at least one hollow groove 5 in the length direction. The hollow groove 5 is provided extending along the height direction of the tool head 3 and penetrating from one side wall in the width direction of the tool head 3 to the other side wall. Or, the hollow groove 5 does not penetrate from one side wall in the width direction of the tool head 3 to the other side wall, so as to make the hollow groove 5 in the form of a blind groove. The amplitude transformer 2 is connected to the center point of the tool head 3 along the length direction, and such an arrangement will inevitably lead to a larger ultrasonic amplitude in the center of the tool head 3 along the length direction and smaller on both sides. This problem can be avoided by the hollow groove 5, which scatters the ultrasonic waves and redistributes the sound field so that it is more evenly distributed along the length direction of the tool head 3. The hollow groove 5 is provided near the side of the tool head 3 that is connected to the amplitude transformer 2. The hollow groove 5 may be provided on the first head portion 34 and extend to the second head portion 35.

The large-volume ultrasonic tubular reactor of the present embodiment is provided with a tool head 3 structure in the shape of a column. The fluid tube 4 is provided inside the tool head 3 away from the side of the tool head 3 connected to the amplitude transformer 2, so as to make the processing cost of the fluid tube 4 low. While the fluid tube 4 is large in length and volume, it is possible to ensure that the dispersed ultrasonic energy converge into the fluid tube 4, so as to intensify the mixing of the fluid in the fluid tube. The width of the lower side of the tool head 3 is preferably 0.25-0.75 times the width of the upper side, and the width of the lower side is smaller than the width of the upper side, which allows for a greater amplitude of ultrasonic waves near the lower side within the tool head 3, and allows for more energy to converge into the fluid tube 4. At the same time, the hollow groove 5 provided on the tool head 3 can scatter the ultrasonic waves, redistribute the acoustic field, make the ultrasonic waves more evenly distributed along the length direction of the tool head 3, and avoid the problem of larger ultrasonic amplitude in the center of the tool head 3 along the length direction and smaller ones on both sides caused by the amplitude transformer 2 being connected to the center point of the tool head 3 along the length direction.

### Embodiment 2

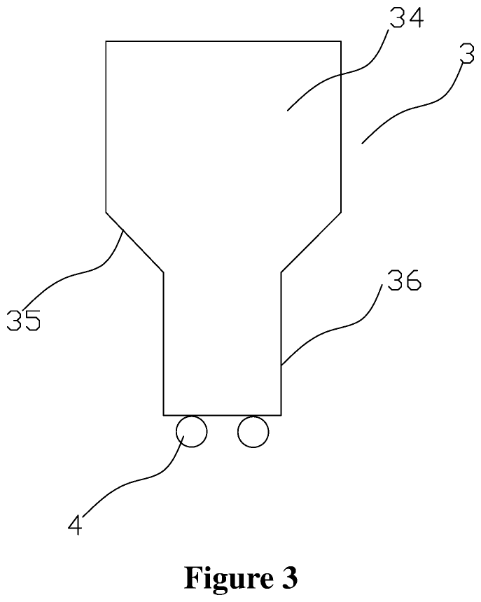

Based on embodiment 1, this embodiment differs from Embodiment 1 in that, as shown in FIG. 3, in this embodiment, the fluid tube 4 is connected to the outer side surface of the side of the tool head 3 away from the amplitude transformer 2. When the fluid tube 4 is connected to the outer wall of the lower side of the tool head 3, the fluid tube 4 is a hollow tube, which can be made of a plastic polymer (e.g., polytetrafluoroethylene PFA), or a material such as glass, metal, alloy, composite material, etc. The fluid tube 4 and the lower side of the tool head 3 can be glued with rigid epoxy resin.

### Embodiment 3

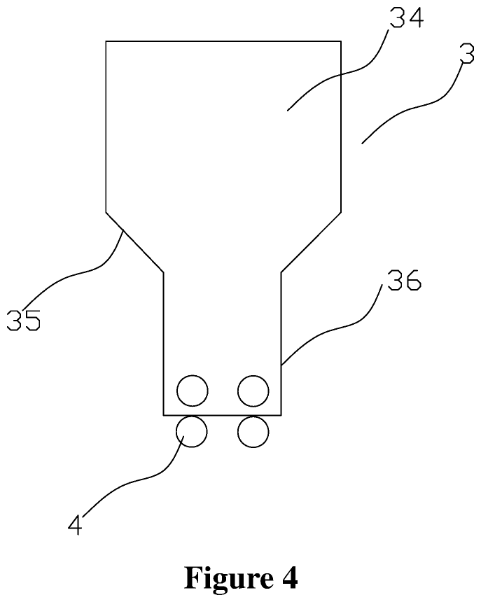

Based on embodiment 1, this embodiment differs from embodiment 1 in that, as shown in FIG. 4, in this embodiment, a part of fluid tubes 4 is provided inside the tool head 3 away from the side of the tool head 3 connected to the amplitude transformer 2, and the other part of the fluid tubes 4 is connected to the outer side surface of the side of the tool head 3 away from the amplitude transformer 2. When the fluid tubes 4 are connected to the outer wall of the lower side of the tool head 3, the fluid tubes 4 are hollow tubes, which can be made of a plastic polymer (e.g., polytetrafluoroethylene PFA), or a material such as glass, metal, alloy, composite material, etc. The fluid tubes 4 and the lower side of the tool head 3 can be glued with rigid epoxy resin.

### Embodiment 4

Based on embodiment 1, this embodiment differs from embodiment 1 in that, in this embodiment, a plurality of groups of fluid tubes 4 are provided along the height direction of the tool head 3. Each group of fluid tubes 4 is provided at the same height, and each group of fluid tubes 4 is connected by the connecting tube 6, so that the plurality of groups of interconnected fluid tubes 4 are provided in parallel with each other along the height direction of the tool head 3, thereby forming a manner in which the fluid tubes 4 are provided in parallel.

### Embodiment 5

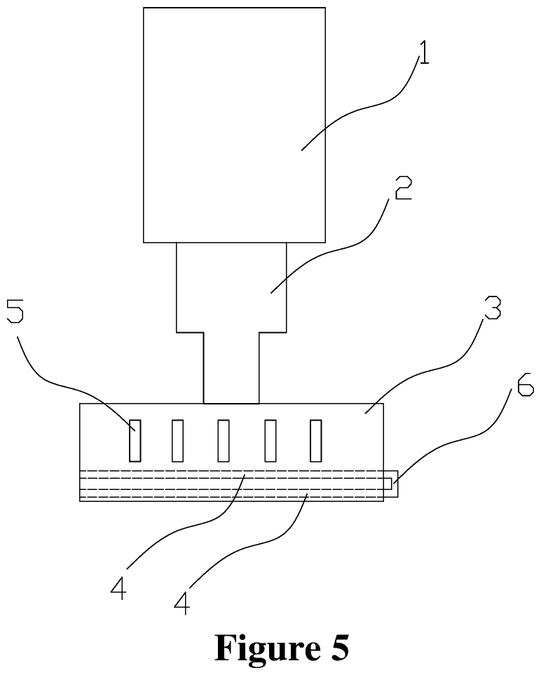

Based on embodiment 1, this embodiment differs from Embodiment 1 in that, in this embodiment, as shown in FIG. 5, a plurality of fluid tubes 4 are provided, and the fluid tubes 4 are arranged along the length direction of the tool head 3. The fluid tubes 4 are provided inside the tool head 3 and close to the lower side of the tool head 3, the fluid tube 4 is directly formed in the tool head 3, and the fluid tube 4 is a straight tube. When there are a plurality of tubes, the fluid tubes 4 are provided in a way of being arranged in series or in parallel with each other, i.e., in a way of being arranged in series in which one end of one fluid tube 4 is connected to one end of the other fluid tube 4 through a connecting tube 6, so as to make the plurality of fluid tubes 4 are connected to each other.

### Embodiment 6

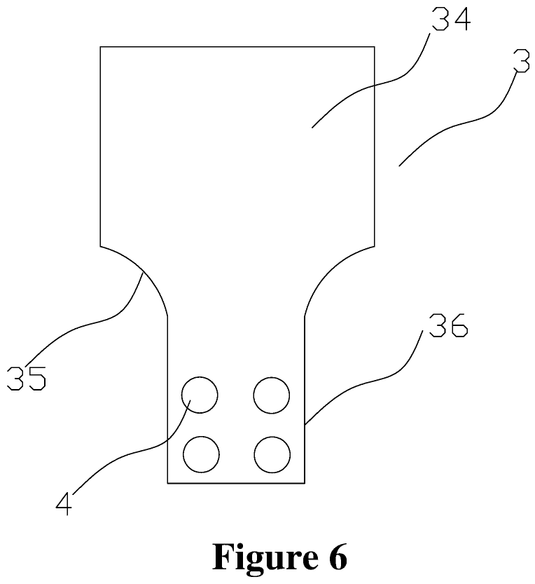

Based on embodiment 1, this embodiment differs from Embodiment 1 in that, in this embodiment, as shown in FIG. 6, the sidewalls on both sides of the second head portion 35 in the width direction are arc-shaped walls. This arrangement makes the second head portion 35 have a circular arc transition, so as to make the ultrasonic waves converge more intensively into the fluid tube 4 in the third head portion 36.

Variations and modifications to the described embodiments may become apparent to experts in the field based on the provided information and teachings. Therefore, it is intended that the present invention not be limited to the particular embodiments disclosed and described above, but that modifications and variations of the present invention will come within the scope of the appended claims. Furthermore, although specific terms are employed herein, they are used in a generic and descriptive sense only and not for purposes of limitation.

1-10. (canceled)

11. A large-volume ultrasonic tubular reactor, comprising:
an ultrasonic transducer (1), the ultrasonic transducer (1) being used for generating ultrasound waves;
an amplitude transformer (2), one end of which being connected to the ultrasonic transducer (1);
a tool head (3), one end of which being connected to the other end of the amplitude transformer (2);
a fluid tube (4), the fluid tube (4) being provided inside the tool head (3) away from the side of the tool head (3) connected to the amplitude transformer (2) or the fluid tube (4) being connected to the outer side surface of the side of the tool head (3) away from the amplitude transformer (2); the amplitude transformer being used for transferring the ultrasonic waves generated by the ultrasonic transducer (1) to the tool head (3), and the tool head (3) being used to converge the ultrasonic energy inside the tool head (3) into the fluid tube (4).

12. The large-volume ultrasonic tubular reactor according to claim 11, wherein the tool head (3) has a columnar structure along its length direction, the height direction of the tool head (3) is the same as the length direction of the amplitude transformer (2), and the width of the tool head (3) extending along the width direction of the tool head (3) is smaller than the length of the tool head (3) extending along the length direction of the tool head (3).

13. The large-volume ultrasonic tubular reactor according to claim 11, wherein the tool head (3) has a flat columnar structure along its length direction.

14. The large-volume ultrasonic tubular reactor according to claim 11, wherein the tool head (3) has a height of half the wavelength of the ultrasonic waves, and the ultrasonic waves vibrate longitudinally along the height direction within the tool head (3).

15. The large-volume ultrasonic tubular reactor according to claim 12, wherein the tool head (3) has a height of half the wavelength of the ultrasonic waves, and the ultrasonic waves vibrate longitudinally along the height direction within the tool head (3).

16. The large-volume ultrasonic tubular reactor according to claim 13, wherein the tool head (3) has a height of half the wavelength of the ultrasonic waves, and the ultrasonic waves vibrate longitudinally along the height direction within the tool head (3).

17. The large-volume ultrasonic tubular reactor according to claim 11, wherein the tool head (3) has a length of 20-1000 mm and has a width of 10-1000 mm.

18. The large-volume ultrasonic tubular reactor according to claim 12, wherein the tool head (3) has a length of 20-1000 mm and has a width of 10-1000 mm.

19. The large-volume ultrasonic tubular reactor according to claim 13, wherein the tool head (3) has a length of 20-1000 mm and has a width of 10-1000 mm.

20. The large-volume ultrasonic tubular reactor according to claim 17, wherein the tool head (3) has a length of 50-500 mm and has a width of 15-60 mm.

21. The large-volume ultrasonic tubular reactor according to claim 18, wherein the tool head (3) has a length of 50-500 mm and has a width of 15-60 mm.

22. The large-volume ultrasonic tubular reactor according claim 19, wherein the tool head (3) has a length of 50-500 mm and has a width of 15-60 mm.

23. The large-volume ultrasonic tubular reactor according to claim 11, wherein the width of the tool head (3) on the side of the tool head (3) connected to the amplitude transformer (2) is greater than or equal to the width of the tool head (3) away from the side of the tool head (3) connected to the amplitude transformer (2).

24. The large-volume ultrasonic tubular reactor according to claim 11, wherein the tool head (3) is provided with at least one hollow groove (5) along the length direction of the tool head (3), the hollow groove (5) is provided extending along the height direction of the tool head (3) and penetrating from one side wall in the width direction of the tool head (3) to the other side wall.

25. The large-volume ultrasonic tubular reactor according to claim 12, wherein the tool head (3) is provided with at least one hollow groove (5) along the length direction of the tool head (3), the hollow groove (5) is provided extending along the height direction of the tool head (3) and penetrating from one side wall in the width direction of the tool head (3) to the other side wall.

26. The large-volume ultrasonic tubular reactor according to claim 13, wherein the tool head (3) is provided with at least one hollow groove (5) along the length direction of the tool head (3), the hollow groove (5) is provided extending along the height direction of the tool head (3) and penetrating from one side wall in the width direction of the tool head (3) to the other side wall.

27. The large-volume ultrasonic tubular reactor according to claim 17, wherein the tool head (3) is provided with at least one hollow groove (5) along the length direction of the tool head (3), the hollow groove (5) is provided extending along the height direction of the tool head (3) and penetrating from one side wall in the width direction of the tool head (3) to the other side wall.

28. The large-volume ultrasonic tubular reactor according to claim 11, wherein the amplitude transformer (2) is a stepped cylinder or a stepped round platform, the ultrasonic waves vibrate along the length direction of the amplitude transformer (2), and the total length of the amplitude transformer (2) is an integer multiple of half the wavelength of the ultrasonic waves.

29. The large-volume ultrasonic tubular reactor according to claim 12, wherein the amplitude transformer (2) is a stepped cylinder or a stepped round platform, the ultrasonic waves vibrate along the length direction of the amplitude transformer (2), and the total length of the amplitude transformer (2) is an integer multiple of half the wavelength of the ultrasonic waves.

30. The large-volume ultrasonic tubular reactor according to claim 11, wherein one or more fluid tubes (4) are provided, and the fluid tubes (4) are arranged along the length direction of the tool head (3).

31. The large-volume ultrasonic tubular reactor according to claim 12, wherein one or more fluid tubes (4) are provided, and the fluid tubes (4) are arranged along the length direction of the tool head (3).
